(19) United States
(12) Patent Application Publication
(10) Pub. No.: US 2006/0022951 A1
(43) Pub. Date: Feb. 2, 2006

(54) Method and apparatus for backlighting of a keyboard for use with a game device

(75) Inventor: Eric J. Hull, Seattle, WA (US)

Correspondence Address: DARBY & DARBY P.C., P. O. BOX 5257, NEW YORK, NY, 10150-5257, US

(73) Assignee: Infinium Labs, Inc.

(21) Appl. No.: 10/910,510

(22) Filed: Aug. 2, 2004

(51) Int. Cl. G09G 5/00

(52) U.S. Cl. 345/170

(57) ABSTRACT

An apparatus and method are directed to enabling backlighting of a modified keyboard employing various mechanisms to enhance a game playing experience. Such mechanisms may include, for example, programmable Light Emitting Diodes (LEDs) that are configured within each key on the modified keyboard. The LEDs may be arranged to vary color, intensity, and duration of lighting for each key. Lighting of the keys may be programmed to dynamically vary based on a game use. For example, in one embodiment, keys may be dynamically color coded according to a use, such as red for keys that may be employed for managing a weapon in the game, green for keys that may be employed to direct movement, and so forth. In another embodiment, the lighting mechanism may include programmable Liquid Crystal Displays (LCDs), that are configured to enable a dynamic display of text and icons on the key face.

### FIELD OF THE INVENTION

The invention relates generally to electronic interactive game play, and more particularly but not exclusively to an apparatus and method for backlighting of keys within a keyboard for use with a game device.

### BACKGROUND OF THE INVENTION

Keyboards for use with computers and other devices have taken a variety of shapes, colors, and configurations to attract the interest of computing enthusiasts, gamers, and mainstream users, as well as for ergonomic considerations. Keyboard designs have often followed the earlier designs of typewriters which were developed primarily to type text documents. However, computers and other keyboard entry based devices have been extended to uses other than text document preparation, such as graphics, and games.

In many games, the keyboard and its keys are used to input commands for the game using a keystroke of combination of keystrokes. Some games require swift pressing of the keys during the game play. Other games may have a large number of possible commands with many different keystrokes or key combinations. Moreover, the keystrokes or key combinations that may be available to the gamer may vary across different games, as well as within various portions of a game session. Present keyboards may not be conveniently designed for gaming or similar applications. Thus, it is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client device that may be employed in a system implementing the invention;

FIG. 3 illustrates a schematic top view of one embodiment of a modified keyboard showing highlighting of selected keys;

FIG. 4 illustrates a schematic top view of one embodiment of a modified keyboard showing dimming of non-selected keys;

FIG. 5 illustrates a schematic top view of one embodiment of a modified keyboard showing dynamic labeling of keys; and

FIGS. 6A-C illustrates a schematic top view of one embodiment of a modified keyboard showing animation using a selection of keys, in accordance with the invention.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, or an embodiment combining software and hardware aspects. The following detailed description is, therefore, not to be taken in a limiting sense.

Briefly stated, the invention is directed towards modified keyboards employing various backlighting mechanisms to enhance a game playing experience. Such lighting mechanisms may employ, for example, programmable Light Emitting Diodes (LEDs) that are configured within each key on the modified keyboard. The LEDs may be arranged to vary in color, intensity, and duration of lighting. Lighting of the keys may be programmed to dynamically vary based on a game use.

For example, in one embodiment, keys may be dynamically color coded according to use, such as red for keys that may be employed for managing a weapon in the game, green for keys that may be employed to direct movement in the game, and so forth. In another embodiment, the lighting mechanism may include programmable Liquid Crystal Displays (LCDs), and the like, that are configured to enable a dynamic display of differing text, icons, graphics, symbols, and the like on the key face. However, the present invention is not limited to LED and LCD technologies, and virtually any mechanism may be employed to dynamically backlight keys on the modified keyboard based, in part, on an application.

It will become apparent that although the discussions make reference to a game use, the invention is not so limited. For example, dynamically backlighting of keys on a modified keyboard may be implemented for use with virtually any program, including, but not limited to, a word processor, a graphical program, an audio application, and so forth.

Illustrative Operating Environment

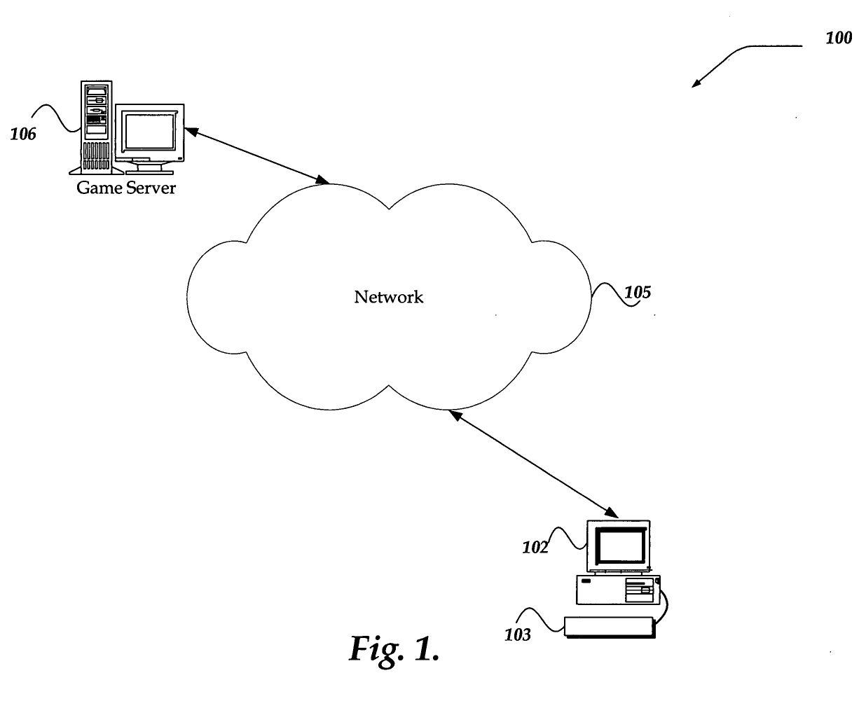

FIG. 1 illustrates one embodiment of an environment in which the invention may operate. Not all the components may be required to practice the invention, and variations in the arrangement and type of the components may be made without departing from the spirit or scope of the invention.

As shown in the figure, system 100 includes client device 102 with modified keyboard 103, network 105, and game server 106. Network 105 is in communication with and enables communication between client device 102 and game server 106.

Game server 106 includes virtually any network device configured to include a game server program, and the like. As such, game server 106 may be implemented on a variety of computing devices including personal computers, desktop computers, multiprocessor systems, microprocessor-based devices, network PCs, servers, network appliances, and the like. In one embodiment, game server 106 is configured to stream an application, data, and the like, associated with, for example, a game, to client device 102 over network 105. In another embodiment, game server 106 may stream a signal to client device 102 that enable modified keyboard 103 to backlight selected keys. As employed throughout the specification, and in the claims, the term “signal” includes, but, is not limited to a current signal, a voltage signal, and a data signal.

Network 105 is configured to couple client device 102 to game server 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G) generation radio access for cellular systems, Wireless-LAN, Wireless Router (WR) mesh, and the like. Access technologies such as 2G, 3G, and future access networks may enable wide area coverage for mobile devices, such as client device 102 with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link. In essence, network 105 includes any communication method by which information may travel between client device 102 and game server 106.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

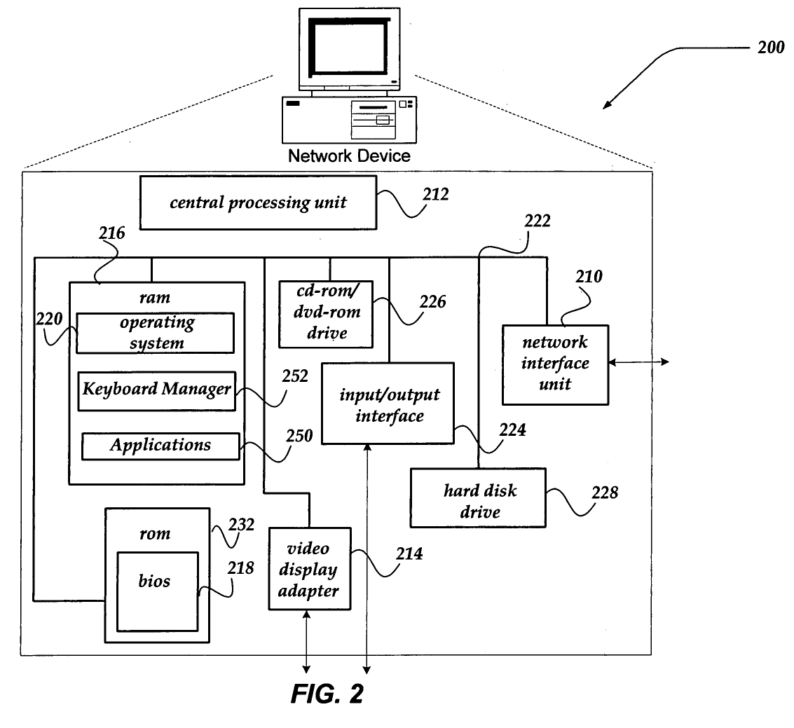

Client device 102 is described in more detail below in conjunction with FIG. 2. Briefly, however, client device 102 may include virtually any computing device capable of connecting to another computing device to send and receive information, including game information, and other interactive information. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device, and the like. Similarly, client device 102 may be any device that is capable of connecting using a wired or wireless communication medium such as a PDA, POCKET PC, wearable computer, and any other device that is equipped to communicate over a wired and/or wireless communication medium.

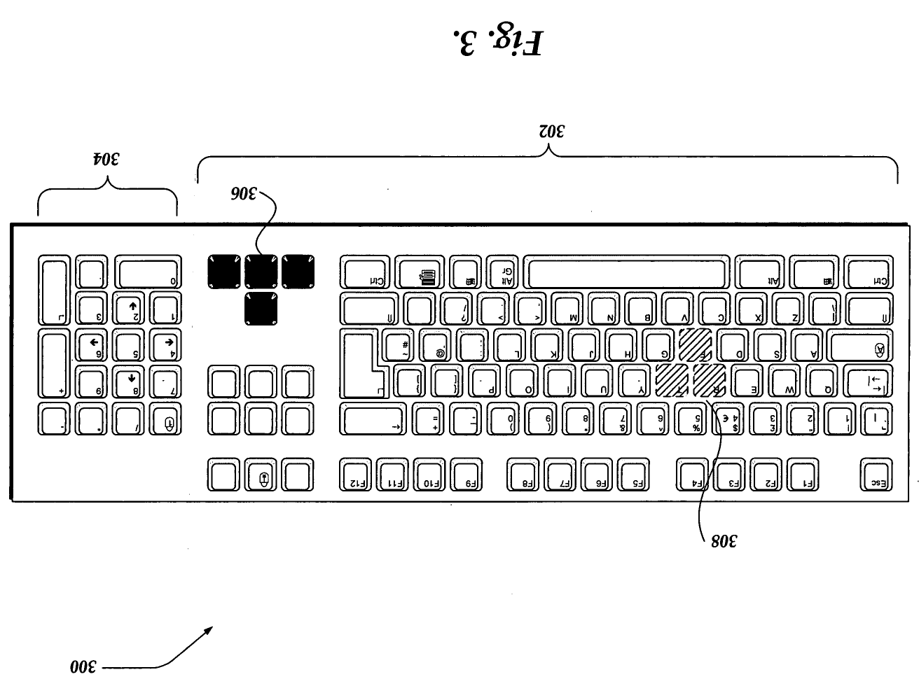

Client device 102 may further include a client application, and the like, that is configured to manage various actions, including, but not limited to enabling an end-user to select and play a game. As described in conjunction with FIG. 2, client device 102 may also include an application that enables backlighting of modified keyboard 103. Modified keyboard 103 is described in more detail in conjunction with FIGS. 3-6.

Briefly, however, modified keyboard 103 can be coupled to client device 102 in any of a variety of wired or wireless manners using virtually any local communication protocol. In one embodiment, modified keyboard 103 is configured to receive signals that result in lighting of selected keys.

While game server 106 and client 102 are illustrated as distinct devices for a game server and a game client application, the present invention is not so constrained. For example, the game server and game client applications may reside within a single device, such as client 102. Moreover, although FIG. 1 illustrates a client/server architecture, the invention is not so limited, and virtually any configuration may be employed. For example, in one embodiment, the application, data, game, and the like, may reside on client device 102 or be provided by a removable media, such as a CD-ROM, cartridge, DVD, and the like.

Illustrative Client Device

FIG. 2 shows one embodiment of a client device, according to one embodiment of the invention. Client device 200 may include many more components than those shown. The components shown, however, are sufficient to disclose an illustrative embodiment for practicing the invention. Client device 200 may represent, for example, client device 102 of FIG. 1.

Client device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of client device 200. Any general-purpose operating system may be employed. Basic input/output system (“BIOS”) 218 is also provided for controlling the low-level operation of client device 200. As illustrated in FIG. 2, client device 200 also can communicate with the Internet, or some other communications network, such as network 105 in FIG. 1, via network interface unit 210, which is constructed for use with various communication protocols including the TCP/IP protocols. For example, in one embodiment, network interface unit 210 may employ a hybrid communication scheme using both TCP and IP multicast with a server device, such as game server 106 of FIG. 1. Network interface unit 210 is sometimes known as a transceiver, transceiving device, or network interface card (NIC).

Client device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion. Moreover, client device 200 may further include applications that support virtually any secure connection, including but not limited to TLS, TTLS, EAP, SSL, IPSec, and the like.

Client device 200 also includes input/output interface 224 for communicating with external devices, such as a mouse, keyboard, scanner, or other input devices not shown in FIG. 2. In one embodiment, client device 200 is configured to send programmable backlighting signals to a modified keyboard, such as shown in FIG. 1. Likewise, client device 200 may further include additional mass storage facilities such as CD-ROM/DVD-ROM drive 226 and hard disk drive 228. Hard disk drive 228 may be utilized to store, among other things, application programs, databases, games, client device information, security information including, but not limited to certificates, ciphers, passwords, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs may include client application, transcoders, schedulers, graphics programs, games, database programs, word processing programs, HTTP programs, user interface programs, various security programs, and so forth. Mass storage may further include applications such as keyboard manager 252.

Keyboard manager 252 is configured to interact with a game program to manage keyboard lighting configuration data. Keyboard manager 252 may receive the configuration data streamed across a network, and/or from an application executing on client device 200. In one embodiment, the configuration data is a file that includes jump points within the file for various lighting instructions associated with the game execution. The lighting instructions may comprise any of a variety of signals that enable selected keys to become lighted, as described below. The signals may control a color, intensity, duration, and the like, for the selected keys.

Illustrative Modified Keyboard and Operation

The operation of certain aspects of the present invention will now be described with respect to FIGS. 3-6. FIG. 3 illustrates a schematic top view of one embodiment of modified keyboard 300 showing highlighting of selected keys. Modified keyboard 300 may include many more components than those shown. The components shown, however, are sufficient to disclose an illustrative embodiment for practicing the invention. Modified keyboard 300 may represent, for example, modified keyboard 103 of FIG. 1.

Modified keyboard 300 is configured such that each key includes a lighting arrangement that may turn on or off based on a received signal. The keys may include a see though structure, comprising virtually any resilient material, including, plastic, and the like. In one embodiment, each key includes a LED within its structure. In another embodiment, each key includes an LCD configured to receive information sufficient to enable it to display varying text, graphics, icons, symbols, and the like. Thus, for example, while a key may display a letter, such as “A,” at one time, it may later display a different letter, symbol, text, and the like, at some other time. Each key may receive a signal that may vary a color, an intensity, and a duration associated with the backlighting of the key.

As shown in FIG. 3, modified keyboard 300 includes alphanumeric keypad 302 and numeric keypad 304. Alphanumeric keypad 302 is illustrated with a standard QWERTY arrangement of numbers, letters, and symbols. It will be understood, however, that other arrangements of numbers, letters, and symbols, can be used, including, but not limited, to the Dvorak arrangement, non-English arrangements, and the like.

Also shown in the figure are two backlit key sets, set 306 and set 308. Although not readily illustrated in black and white, sets 306 and 308 may be backlit employing different colors. For example, set 306 may be backlit in one color, while set 308 may be backlit in another color. Virtually any color scheme may be employed to portray various aspects, operations, and functions associated with a game. For example, set 306 may turn on with one backlit color when the game is configured to receive arrow (directional) inputs, and change to another backlit color when the context of the arrow inputs changes.

Although sets 306 and 308 are illustrated, it should be understand that virtually any key or combination of keys may be backlit based on a desired operation of the application. For example, in one embodiment, a signal may be sent to set 306 that results in one of more keys in set 306 to blink on and off, change color, and the like.

Moreover, various color schemes may be employed using modified keyboard 300. For example, in one embodiment, a key or set of keys may be lit in one color to represent, say weapon keys, while another key or set of keys may be lit in another color to represent, say movement keys.

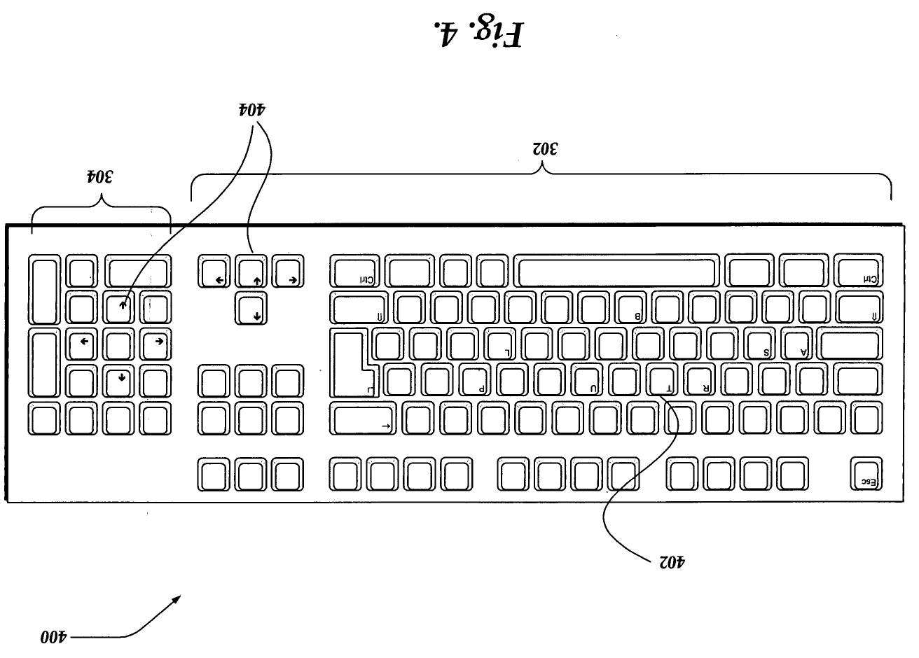

FIG. 4 illustrates a schematic top view of one embodiment of a modified keyboard showing dimming of non-selectable keys. As shown in the figure modified keyboard 400 includes alphanumeric keypad 302 and numeric keypad 304 substantially as described above. Moreover, FIG. 400 includes set 402 of backlit alphanumeric keys, and set 404 of directional arrow backlit keys. As shown in the figure, set 402 illustrates that not all of the keys in alphanumeric keypad 302 are backlit. In the example illustrated, only the letters A, S, R, T, B, U, L, and P (set 402) are backlit. The remaining letters in alphanumeric keypad 302 are not backlit, and as shown, the graphic for each of those letters are not visible. Selection of which keys are to be backlit may be achieved by selectively sending an appropriate signal to a backlight associated with the desired key.

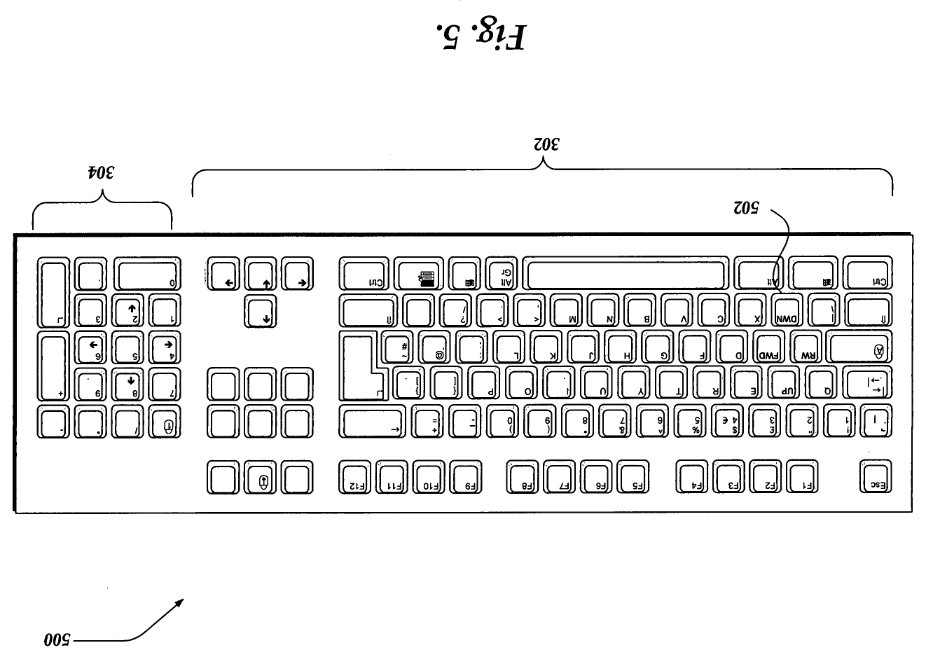

FIG. 5 illustrates a schematic top view of one embodiment of a modified keyboard showing dynamic labeling of keys. As shown in the figure modified keyboard 500 includes alphanumeric keypad 302 and numeric keypad 304 substantially as described above. As shown in the figure, set 502 of keys are configured to display text. Virtually any text may be displayed by a given key or set of keys that may fit within the dimensions of the physical key. For example, as shown, set 502 illustrates the text, “UP,” “RW,” “FWD,” and “DWN.” Such text may be dynamically selected based in part on an application. The application may determine the text to be displayed and send appropriate signals to the key to be backlit. As such, although the example illustrates “UP” for example, the same key may later receive a different set of text to be displayed. Changes to the text may arise, for example, based on events within the game.

Moreover, although not illustrated, each key may be configured to receive a signal that is directed towards enabling a display of a graphic, icon, and the like on a selected key.

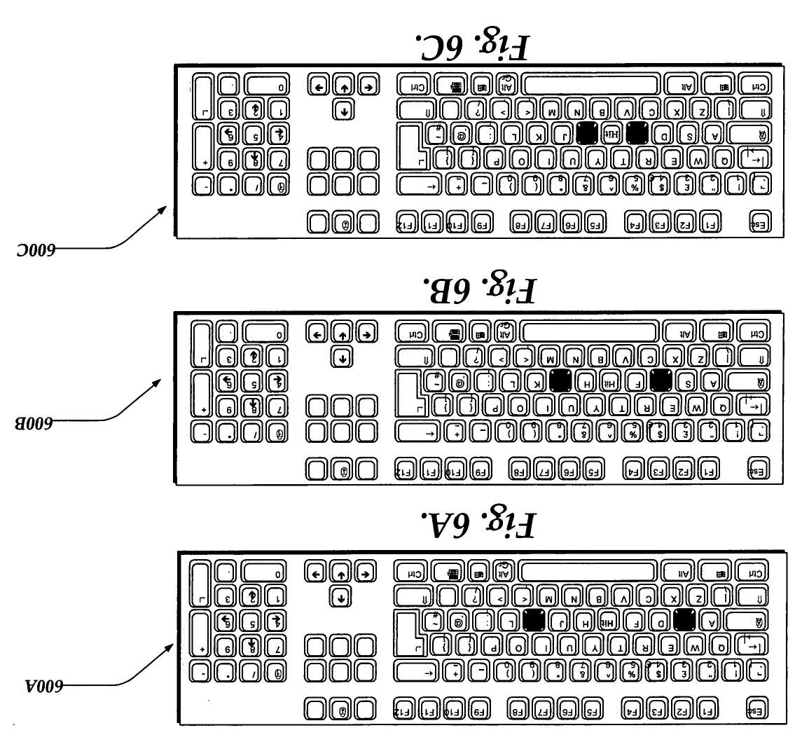

FIGS. 6A-C illustrates a schematic top view of one embodiment of a modified keyboard showing animation of keys, in accordance with the invention. Although it is difficult to illustrate animation, the figures are intended to be viewed sequentially. For example, FIG. 6A illustrates that letters S and K are uniquely backlit. FIG. 6B illustrates that letters D and J are uniquely backlit, rather than letters S and K. Finally, FIG. 6C illustrates that the unique backlighting has moved inwards along a horizontal line of keys to letters F and H. Over time, FIGS. 6A-C may illustrate a strobe event of backlighting converging towards the key backlit with the text “HIT.” Such dynamic animation may be associated with an instruction to the end-user requesting that an indicated key be HIT.

Although not illustrated, such dynamic programming of backlighting of keys may be employed for a variety of other activities. For example, a game may be employed that ‘bounces’ a highlighting of keys randomly around on the modified keyboard. The end-user may then be encouraged to strike the highlighted key before it is no longer highlighted, essentially, chasing the light around the modified keyboard.

It should be clear that the above are merely examples of possible uses of the modified keyboard, and as such, the invention is not limited by such examples. The above specification, examples, and data, however, provide a complete description of the manufacture and use of the composition of the invention. Since many embodiments of the invention can be made without departing from the spirit and scope of the invention, the invention resides in the claims hereinafter appended.

What is claimed as new and desired to be protected by letters patent of the United States is:

1. A method for illuminating a keyboard for use with a game device, the method comprising:
determining a signal based on an interactive game;
providing the signal to the keyboard, wherein the signal is arranged to backlight at least one key on the keyboard by varying at least one of a color, an intensity, and a duration of the backlighting of the at least one key.

2. The method of claim 1, wherein each key further comprises at least one of a light emitting diode (LED), and a liquid crystal diode (LCD).

3. The method of claim 1, wherein providing the signal further comprises determining the signal based on an event in a game application.

4. The method of claim 1, wherein providing the signal further comprises providing the signal to backlight the at least one key with at least one of a letter, a number, text, and an icon.

5. The method of claim 1, wherein providing the signal further comprises changing the signal to backlight the at least one key with a different letter, number, text, or icon.

6. The method of claim 1, wherein providing the signal further comprises strobing the signal to the at least one key and another key.

7. The method of claim 1, wherein providing the signal further comprises selecting at least one other key to vary at least one of its color, intensity, and duration of backlighting.

8. An keyboard, comprising:
An alphanumeric keypad; and
A numeric pad, wherein each key in the alphanumeric keypad and numeric pad are separately configured to receive a signal that varies at least one of a color, an intensity, and a duration of a backlighting of the key.

9. The keyboard of claim 8, wherein the received signal is determined based, in part, on an application.

10. The keyboard of claim 8, wherein each key further comprises at least one of an LCD, and an LED.

11. The keyboard of claim 8, wherein each key is configured to dynamically display at least one of a variable letter, a number, text, and an icon.

12. The keyboard of claim 8, wherein each key is further configured to dynamically change from displaying at least one of a letter, number, text, and icon to displaying at least one of a different letter, number, text, and icon.

13. A modulated data signal for use with a keyboard, the modulated data signal comprising the actions of:
Sending to a client device a signal based on an interactive game;
providing the signal to the keyboard, wherein the signal is arranged to backlight at least one key on the keyboard by varying at least one of a color, an intensity, and a duration of the backlighting of the at least one key.

14. The modulated data signal of claim 13, wherein each key further comprises at least one of a light emitting diode (LED), and a liquid crystal diode (LCD).

15. The modulated data signal of claim 13, wherein providing the signal further comprises determining the signal based on an event in a game application.

16. The modulated data signal of claim 13, wherein providing the signal further comprises providing the signal to backlight the at least one key and to display at least one of a letter, a number, text, and an icon.

17. The modulated data signal of claim 13, wherein providing the signal further comprises strobing the signal to the at least one key.

18. The modulated data signal of claim 13, wherein the signal is sent to the client device within a configuration file.

19. The modulated data signal of claim 13, wherein providing the signal further comprises providing a series of signals that enable a playing of animation on the keyboard by varying at least one of which keys are backlit, the color, the duration, and intensity of backlighting.

20. A system for use in a game, comprising:
a transceiver for receiving and sending information to a computing device;
a processor in communication with the transceiver that is configured to process signals; and
a keyboard comprising a plurality of keys, each key in the plurality of keys being separately configured to receive the signal and in response to the received signal vary at least one of a color, an intensity, and a duration of a backlighting of the key.

21. The system of claim 20, wherein the signal is streamed to the system and includes at least one configuration file.

22. The system of claim 20, wherein providing the signal further comprises providing information within the signal to display at least one of a letter, a number, text, symbol, and an icon on the key.
